(19) United States
(12) Patent Application Publication
(10) Pub. No.: US 2016/0020019 A1
(43) Pub. Date: Jan. 21, 2016

(54) POWER SUPPLYING UNIT, POWER RECEIVING UNIT, AND POWER SUPPLYING SYSTEM

(71) Applicant: YAZAKI CORPORATION, Minato-ku, Tokyo (JP)

(72) Inventors: Kazuyoshi Kagami, Susono-shi (JP); Shingo Tanaka, Yokosuka-shi (JP); Hajime Terayama, Susono-shi (JP)

(21) Appl. No.: 14/772,843

(22) PCT Filed: Mar. 4, 2014
(86) PCT No.: PCT/JP2014/055355

§ 371 Date: Sep. 4, 2015

(30) Foreign Application Priority Data
Mar. 6, 2013 (JP) 2013-044277

(51) Int. Cl. H01F 38/14; H01F 27/36; H02J 5/00

(52) U.S. Cl. CPC H01F 38/14; H02J 5/005; H01F 27/365

(57) ABSTRACT

A power supplying unit includes a power supply, a power supplying side resonant coil that resonates with a power receiving side resonant coil mounted on a vehicle and contactlessly supply the power supplied from the power supply to the power receiving side resonant coil, and a conductive power supplying side shield case for housing the power supplying side resonant coil. A power receiving unit includes the power receiving side resonant coil that electromagnetically resonates with the power supplying side resonant coil and contactlessly receive the power from the power supplying side resonant coil, and a power receiving side shield case for housing the power receiving side resonant coil. A ferrite is disposed outside the power receiving side shield case.

### TECHNICAL FIELD

The present invention relates to a power supplying unit, a power receiving unit, and a power supplying system, especially, a power supplying unit that contactlessly supplies the power, a power receiving unit that contactlessly receives the power, and a power supplying system that includes the power supplying unit and the power receiving unit.

### BACKGROUND ART

In recent years, as a power supplying system for supplying power to a battery mounted on a hybrid vehicle and an electric vehicle, wireless power supplying has been focused that does not use a power supply cord and a power transmission cable. As one of the wireless power supplying technique, that of a resonant type has been known. In the resonant type power supplying system, one of a pair of resonant coils electromagnetically resonant with each other is installed on the ground of a power supplying facility and the other is mounted on a vehicle, and power is contactlessly supplied from the resonant coil installed on the ground of the power supplying facility to the resonant coil mounted on the vehicle. Hereinafter, one of the resonant coil that is installed on the power supplying facility is referred to as a power supplying side resonant coil, and the other of the resonant coil that is mounted on the vehicle is referred to as a power receiving side resonant coil.

The resonant type power supplying system described above has an advantage that power can be supplied wirelessly even when there is some distance between the power supplying side resonant coil and the power receiving side resonant coil. However, since there is the distance between the power supplying side resonant coil and the power receiving side resonant coil, there is a possibility that large electromagnetic leakage occurs in the periphery.

Therefore, as a method for preventing the electromagnetic leakage, as illustrated in FIG. 5 and FIG. 6, it has been considered to provide metal shield frames 103, 104 for surrounding side surfaces of the power supplying side resonant coil 101 and the power receiving side resonant coil 102, and to dispose magnetic bodies 105, 106 at sides away from each other of the power supplying side resonant coil 101 and the power receiving side resonant coil 102 (Patent Literature 1). However, in this method, there has been a problem that the electromagnetic leakage cannot be sufficiently prevented in power supplying of large power that targets the hybrid vehicle and electric vehicle.

Further, when the power receiving side resonant coil 102 is mounted on the vehicle, power may be supplied in a state that the power supplying side resonant coil 101 and the power receiving side resonant coil 102 is positionally displaced. There has also been a problem that, when the power is supplied in such a state, the electromagnetic leakage becomes larger.

### CITATION LIST

### Patent Literature

Patent Literature 1: JP 2011-45189 A

### SUMMARY OF INVENTION

### Technical Problem

Therefore, the present invention aims to provide a power supplying unit, a power receiving unit, and a power supplying system that prevent electromagnetic leakage.

### Solution to Problem

The first aspect of the present invention for solving the problem described above is a power supplying unit including a power supply, a power supplying side resonant coil that resonates with a power receiving side resonant coil mounted on a vehicle for contactlessly supplying power supplied from the power supply to the power receiving side resonant coil, and a conductive shield case for housing the power supplying side resonant coil, the power supplying unit further including a magnetic body outside the shield case.

The second aspect of the present invention is a power receiving unit including a power receiving side resonant coil that is mounted on a vehicle and electromagnetically resonates with a power supplying side resonant coil for contactlessly receiving power from the power supplying side resonant coil, and a conductive shield case for housing the power receiving side resonant coil, the power receiving unit further including magnetic body disposed outside the shield case.

The third aspect of the present invention is a power supplying system including a power supplying unit according to the first aspect, and a power receiving unit according to the second aspect.

The fourth aspect of the present invention is the power supplying system according to the third aspect in which the magnetic body is provided in a plate-like body, and is disposed vertically to a separation direction of the power supplying side resonant coil and the power receiving side resonant coil at the time of supplying power.

### Advantageous Effects of Invention

As described above, according to the first to fourth aspects of the present invention, a magnetic body is disposed outside shield cases for housing a power supplying side resonant coil and a power receiving side resonant coil. As a result, a leakage magnetic field leaked from the shield case of a magnetic field generated by a power supplying side resonant coil is absorbed by a ferrite set outside the shield case, so that electromagnetic leakage can be sufficiently prevented even in a case of a power supplying system of large power.

### BRIEF DESCRIPTION OF DRAWINGS

FIG. 1 is a block diagram illustrating one embodiment of a power supplying system of the present invention;

FIG. 2 is a perspective view of the power supplying system illustrated in FIG. 1 in a first embodiment;

FIG. 3 is a perspective view of the power supplying system illustrated in FIG. 2 in a second embodiment;

FIG. 4 is a graph illustrating simulation results of a leakage magnetic field to a distance from the center of a resonant coil, for a present invention product A that is a power supplying system in which a ferrite is provided at a power receiving unit side illustrated in FIG. 2 described in the first embodiment, a present invention product B in which the ferrite is provided at a power supplying unit side illustrated in FIG. 3 described in the second embodiment, and a comparative product that is a power supplying system in which the ferrite is not provided;

FIG. 5 is a perspective view illustrating one example of a conventional power supplying system; and

FIG. 6 is a I-I line cross sectional view of FIG. 5.

### DESCRIPTION OF EMBODIMENTS

### First Embodiment

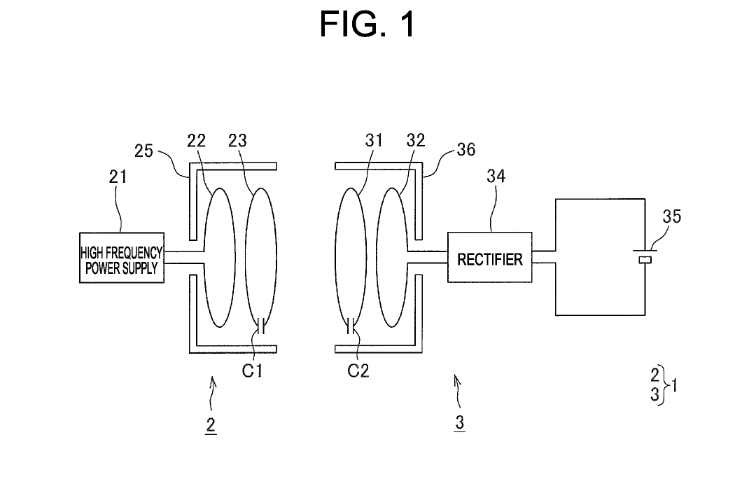

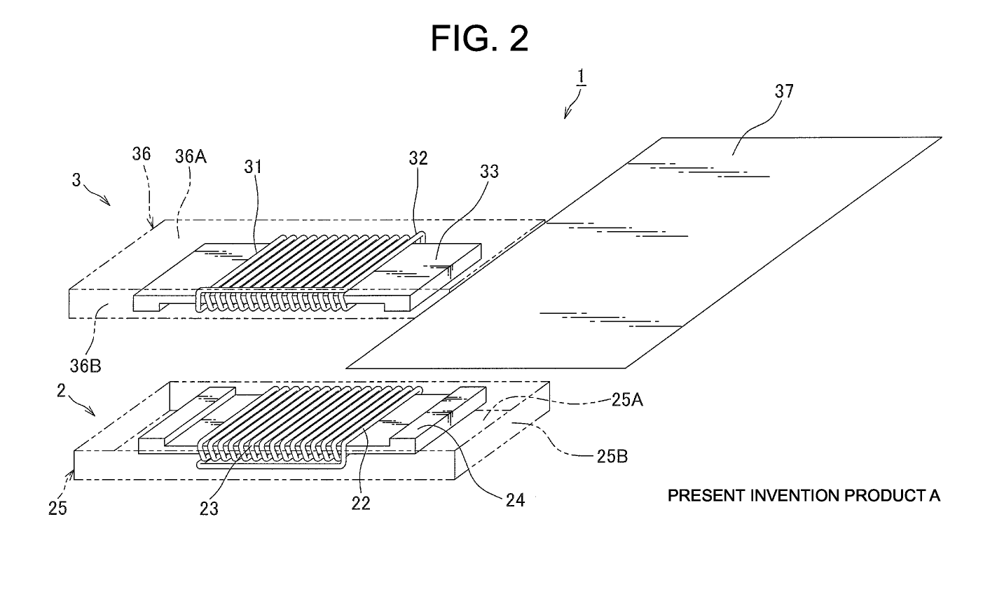

Hereinafter, a power supplying system of the present invention in a first embodiment will be described with reference to FIG. 1 and FIG. 2. FIG. 1 is a block diagram illustrating one embodiment of the power supplying system of the present invention. FIG. 2 is a perspective view of the power supplying system illustrated in FIG. 1 in the first embodiment. As illustrated in FIG. 1, the power supplying system 1 includes a power supplying unit 2 provided in a power supplying facility, and a power receiving unit 3 mounted on a vehicle.

The power supplying unit 2, as illustrated in FIG. 1, includes a high frequency power supply 21 as a power supply, a power supplying side loop antenna 22 to which high frequency power from the high frequency power supply 21 is supplied, a power supplying side resonant coil 23 electromagnetically coupled with the power supplying side loop antenna 22, a power supplying side core 24 around which the power supplying side loop antenna 22 and the power supplying side resonant coil 23 are wound (see FIG. 2), a power supplying side capacitor C1 connected across both ends of the power supplying side resonant coil 23, and a power supplying side shield case 25 for housing the power supplying side loop antenna 22 and the power supplying side resonant coil 23.

The high frequency power supply 21 generates the high frequency power to supply the power to the power supplying side loop antenna 22. The high frequency power to be generated by the high frequency power supply 21 is provided so that the frequency is equal to a resonant frequency (for example, 13.56 MHz) of the power supplying side resonant coil 23 and the power receiving side resonant coil 31 to be described later.

The power supplying side loop antenna 22, as illustrated in FIG. 2, is configured by winding a conductive wire around the power supplying side core 24, and is provided so that its central axis is vertical to the separation direction (vertical direction) of the power supplying side resonant coil 23 and the power receiving side resonant coil 31 at the time of supplying power, namely, along the horizontal direction. To both ends of the power supplying side loop antenna 22, the high frequency power supply 21 is connected, and the high frequency power from the high frequency power supply 21 is supplied.

The power supplying side resonant coil 23, as illustrated in FIG. 2, is configured by helically winding the conductive wire around the power supplying side core 24. That is, the power supplying side resonant coil 23 is disposed on the same axis as the power supplying side loop antenna 22. The power supplying side resonant coil 23 is also provided so that its central axis is vertical to the separation direction (vertical direction) of the power supplying side resonant coil 23 and the power receiving side resonant coil 31 at the time of supplying power, namely, along the horizontal direction. To both ends of the power supplying side resonant coil 23, the power supplying side capacitor C1 for adjusting the resonant frequency is connected.

The power supplying side loop antenna 22 and the power supplying side resonant coil 23 are provided to be separated from each other in a range in which they can be electromagnetically coupled with each other, namely, in a range in which high frequency power is supplied to the power supplying side loop antenna 22 and, when high frequency current flows, electromagnetic induction is generated to the power supplying side resonant coil 23.

The power supplying side core 24 is configured from a magnetic body such as ferrite, and provided in a substantially flat plate-like shape. The core 24 is disposed horizontally.

The power supplying side shield case 25 is configured from a highly conductive metal shield such as copper and aluminum. The power supplying side shield case 25 is configured of a bottom wall 25A that covers a side away from the power receiving side resonant coil 31 to be described later of the power supplying side loop antenna 22 and power supplying side resonant coil 23, and a standing wall 25B that stands from a peripheral edge of the bottom wall 25A, and is provided in a box shape in which the power receiving unit 3 side is opened. The bottom wall 25A is provided in a slightly larger rectangular shape than the power supplying side core 24. The standing wall 25B is provided to surround the side surface of the power supplying side core 24.

The power receiving unit 3, as illustrated in FIG. 1, includes the power receiving side resonant coil 31 that electromagnetically resonates with the power supplying side resonant coil 23, a power receiving side loop antenna 32 electromagnetically coupled with the power receiving side resonant coil 31, a power receiving side core 33 around which the power receiving side loop antenna 32 and the power receiving side resonant coil 31 are wound (see FIG. 2), a power receiving side capacitor C2 connected across both ends of the power receiving side resonant coil 31, a rectifier 34 that converts the high frequency power received by the power receiving side loop antenna 32 to DC power, a vehicle mounted battery 35 to which the DC power converted by the rectifier 34 is supplied, a power receiving side shield case 36 for housing the power receiving side loop antenna 32 and the power receiving side resonant coil 31, and a ferrite 37 as a magnetic body disposed outside the power receiving side shield case 36 (see FIG. 2).

The power receiving side resonant coil 31 is provided in the same size and shape as the power supplying side resonant coil 23 described above, and is provided so that its central axis is vertical to the separation direction (vertical direction) of the power supplying side resonant coil 23 and the power receiving side resonant coil 31, namely, along the horizontal direction. The power receiving side loop antenna 32 is provided in the same size and shape as the power supplying side loop antenna 22. The power receiving side resonant coil 31 and the power receiving side loop antenna 32 are wound around the power receiving side core 33, thus are both disposed on the same axis. Across the both ends of the power receiving side resonant coil 31, a power receiving side capacitor C2 for the resonant frequency is connected.

Further, the power receiving side resonant coil 31 and the power receiving side loop antenna 32 are provided to be separated from each other in a range in which they are electromagnetically coupled with each other, namely, in a range in which, when AC current flows through the power receiving side resonant coil 31, induction current is generated in the power receiving side loop antenna 32.

The power receiving side shield case 36, as illustrated in FIG. 2, is configured from a highly conductive metal shield such as copper and aluminum in the same manner as the power supplying side shield case 25. The power receiving side shield case 36 is configured of a bottom wall 36A that covers a side away from the power supplying side resonant coil 23 to be described later of the power receiving side loop antenna 32 and the power receiving side resonant coil 31, and a standing wall 36B that stands from a peripheral edge of the bottom wall 36A, and is provided in a box shape in which the power supplying unit 2 side is opened.

The bottom wall 36A is provided in a slightly larger rectangular shape than the power receiving side core 33. The standing wall 36B is provided to surround the side surface of the power receiving side core 33. The ferrite 37 is provided in a flat plate-like shape, and is disposed adjacent to the power receiving side shield case 36. The ferrite 37 is provided vertically to the separation direction (vertical direction) of the power supplying side resonant coil 23 and the power receiving side resonant coil 31, namely, horizontally.

According to the power supplying system 1 described above, when the power receiving unit 3 of the vehicle approaches the power supplying unit 2 provided on the ground of the power supplying facility and then the power supplying side resonant coil 23 and the power receiving side resonant coil 31 electromagnetically resonate with each other, power is contactlessly supplied from the power supplying unit 2 to the power receiving unit 3, and the vehicle mounted battery 35 is charged.

In detail, when the AC current is supplied to the power supplying side loop antenna 22, the power is transmitted to the power supplying side resonant coil 23 by electromagnetic induction. That is, to the power supplying side resonant coil 23, the power is supplied via the power supplying side loop antenna 22. When the power is transmitted to the power supplying side resonant coil 23, the power is wirelessly transmitted to the power receiving side resonant coil 31 by resonance of the magnetic field. Furthermore, when the power is transmitted to the power receiving side resonant coil 31, the power is transmitted to the power receiving side loop antenna 32 by electromagnetic induction, and the vehicle mounted battery 35 connected to the power receiving side loop antenna 32 is charged.

According to the power supplying system 1 described above, the ferrite 37 is disposed outside the power receiving side shield case 36 that houses the power receiving side resonant coil 31. As a result, a leakage magnetic field leaked from the shield cases 25, 36 of the magnetic field generated by the power supplying side resonant coil 23 is absorbed by the ferrite 37 set outside the shield cases 25, 36, so that electromagnetic leakage can be sufficiently prevented even in a case of a power supplying system of large power.

### Second Embodiment

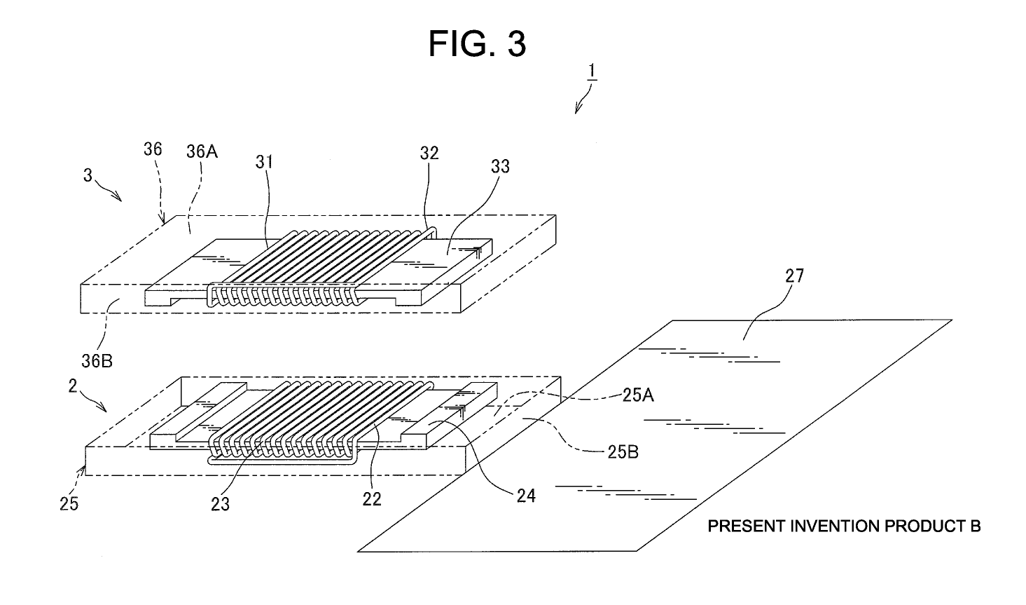

Next, a second embodiment will be described with reference to FIG. 3. A difference from the first embodiment is that the ferrite 37 of the power receiving unit 3 side is removed and a ferrite 27 is provided at the power supplying unit 2 side instead. The ferrite 27 is provided outside the power supplying side shield case 25 and in a flat plate-like shape. The ferrite 27, similar to the first embodiment, is disposed vertically to the separation direction of the power supplying side resonant coil 23 and the power receiving side resonant coil 31 at the time of supplying power. In this case too, similar to the first embodiment, the leakage magnetic field leaked from the outside of the shield cases 25, 36 of the magnetic field generated by the power supplying side resonant coil 23 is absorbed by the ferrite 27 set outside the shield cases 25, 36, so that electromagnetic leakage can be sufficiently suppressed even in a case of a power supplying system of large power.

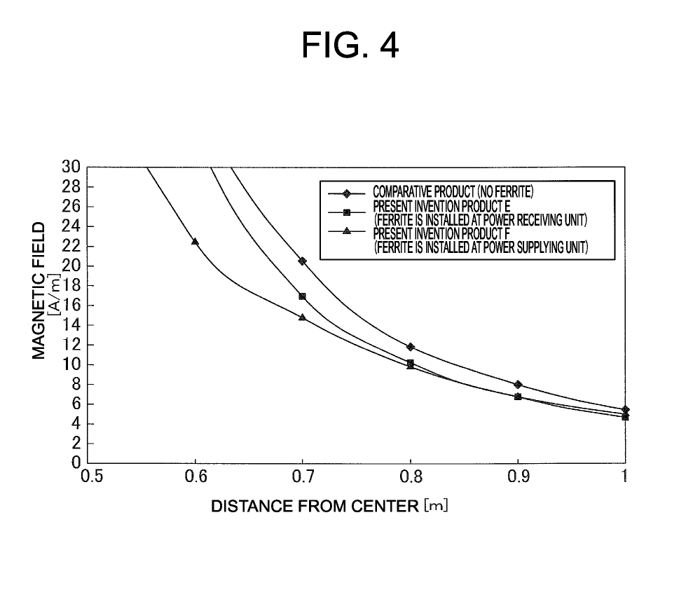

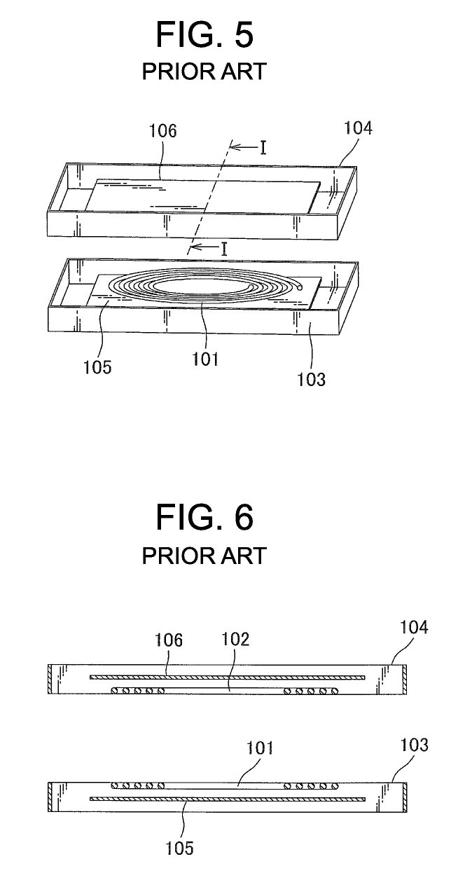

Next, the present inventors, in order to confirm the effect described above, have performed a simulation of the leakage magnetic field to a distance from the centers of the resonant coils 23, 31, for a present invention product A that is a power supplying system 1 in which the ferrite 37 is provided at the power receiving unit 3 side illustrated in FIG. 2 described in the first embodiment, a present invention product B in which the ferrite 27 is provided at the power supplying unit 2 side illustrated in FIG. 3 described in the second embodiment, and a comparative product (not illustrated) that is a power supplying system 1 in which the ferrite is not provided. The result is illustrated in FIG. 4.

Incidentally, in the simulation, a power of 3 kW is supplied to the power supplying side resonant coil 23. Further, the simulation has been performed using equivalent coils (same shape, same size, same material) as the power supplying side resonant coil 23 and the power receiving side resonant coil 31 for each of the present invention products A, B and the comparative product.

Further, the simulation has been performed using equivalent antennas as the power supplying side loop antenna 22 and the power receiving side loop antenna 32 for each of the present invention products A, B and the comparative product. That is, a difference between the present invention product A and the present invention product B is only whether the ferrites 27, 37 are installed at the power receiving unit 3 side or the power supplying unit 2 side, and any other portions are set equally. Further, a difference between the present invention products A, B and the comparative products is only whether the ferrites 27, 37 exist or not, and any other portions have been set equally.

As illustrated in FIG. 4, it has been confirmed that the present invention products A, B has suppressed expansion of a leakage magnetic field distribution more than the comparative product. For example, at the point of 0.7 m, it has been confirmed that the leakage magnetic field can be reduced by 4 to 6 A/m in the present invention products A, B in which the ferrites 27, 37 are disposed, in comparison with the comparative product in which the ferrites 27, 37 are not disposed.

Incidentally, in the first and second embodiments described above, although the ferrites 27, 37 have been provided at only one of the power supplying unit 2 and the power receiving unit 3, the present invention is not limited thereto. The ferrites 27, 37 may be provided at both of the power supplying unit 2 and the power receiving unit 3.

Further, in the first and second embodiments described above, although the ferrite 27, 37 have been provided at only one side in the longitudinal direction of the shield cases 25, 36, they may be provided at the other side, may be provided at the short direction side, and may be provided to surround four sides.

Further, in the first and second embodiments described above, although the central axes of the resonant coils 23, 31 have been provided vertically to the separation direction of the power supplying side resonant coil 23 and the power receiving side resonant coil 31 at the time of supplying power, the present invention is not limited thereto. The resonant coil may be any of those that can contactlessly supply power by electromagnetic resonance, and, for example, may be provided so that its central axis is along the separation direction.

Further, in the first and second embodiments described above, although the resonant coils 23, 31 have been wound helically, the present invention is not limited thereto. The resonant coil may be any of those that can contactlessly supply power by electromagnetic resonance, and for example, may be wound spirally.

Further, in the first and second embodiments described above, although the power supplying side resonant coil 23 has received supply of power via the power supplying side loop antenna 22, it may receive power supplying directly from the high frequency power supply 21 without intervention of the power supplying side loop antenna 22.

Further, in the first and second embodiments described above, although the power receiving side resonant coil 31 has supplied power to the vehicle mounted battery 35 via the power receiving side loop antenna 32, the power may be supplied directly to the vehicle mounted battery 35 without intervention of the power receiving side loop antenna 32.

Further, the embodiments described above have shown merely exemplary form of the present invention, and the present invention is not limited to the embodiments. That is, it can be implemented in various modifications without departing from the gist of the present invention.

### REFERENCE SIGNS LIST

1 power supplying system
2 power supplying unit
3 power receiving unit
21 high frequency power supply (power supply)
23 power supplying side resonant coil (power supplying coil)
25 power supplying side shield case (shield case)
27 ferrite (magnetic body)
31 power receiving side resonant coil
36 power receiving side shield case (shield case)
37 ferrite (magnetic body)

1. A power supplying unit comprising: a power supply; a power supplying side resonant coil that resonates with a power receiving side resonant coil mounted on a vehicle for contactlessly supplying power supplied from the power supply to the power receiving side resonant coil; and a conductive shield case for housing the power supplying side resonant coil,
wherein the power supplying unit further has a magnetic body disposed outside the shield case.

2. A power receiving unit comprising: a power receiving side resonant coil that is mounted on a vehicle and electromagnetically resonates with a power supplying side resonant coil for contactlessly receiving power from the power supplying side resonant coil; and a conductive shield case for housing the power receiving side resonant coil,
wherein the power receiving unit further has a magnetic body disposed outside the shield case.

3. A power supplying system comprising
a power supplying unit described in claim 1, and
a power receiving unit comprising: a power receiving side resonant coil that is mounted on a vehicle and electromagnetically resonates with a power supplying side resonant coil for contactlessly receiving power from the power supplying side resonant coil; and a conductive shield case for housing the power receiving side resonant coil,
wherein the power receiving unit further has a magnetic body disposed outside the shield case.

4. The power supplying system according to claim 3,
wherein the magnetic body is provided in a plate-like shape, and is disposed vertically to a separation direction of the power supplying side resonant coil and the power receiving side resonant coil at the time of supplying power.
